(19) United States
(12) Patent Application Publication
(10) Pub. No.: US 2016/0368380 A1
(43) Pub. Date: Dec. 22, 2016

(54) ELECTRONIC DISPLAY DEVICE MOUNTED ON A VEHICLE FOR DYNAMIC COMMUNICATION

(71) Applicant: Ronald D. Nottingham, JR., Frederick, MD (US)

(72) Inventor: Ronald D. Nottingham, JR., Frederick, MD (US)

(21) Appl. No.: 14/745,883

(22) Filed: Jun. 22, 2015

(51) Int. Cl. B60K 35/00; G08B 5/36; G08B 5/38; G09G 3/14

(52) U.S. Cl. CPC B60K 35/00; G09G 3/14; G08B 5/36; G08B 5/38; B60K 2350/106; B60K 2350/20

(57) ABSTRACT

An electronic vehicle accessory device adapted to fit on a dashboard of a vehicle includes a control, communication, and power circuit board that processes an input from a communication device that includes text; a display unit that includes a light-emitting diode (LED) circuit board including a plurality of light-emitting diodes adapted to dynamically display an electronic sign that includes the text received from the communication device; a translucent lens positioned in front of the LED circuit board to diffuse the electronic sign from the LED circuit board; a housing unit that encloses the LED circuit board, the control, communication, and power circuit board, and the translucent lens; a plurality of legs including any of elastomeric, plastic, and adhesive material that are adapted to be stably but removably fixed on the dashboard of the vehicle; and an inclined front surface adapted to fit adjacent to a windshield of the vehicle.

### BACKGROUND

Technical Field

The embodiments herein generally relate to vehicle communication, and more particularly to a removable and stable electronic display device mounted on a vehicle for dynamic communication with persons within a viewing range of the vehicle.

Description of the Related Art

With the constant increase in the number of automobiles traveling on roads, maintaining safety has become challenging. In the case of high-speed traffic, which is encountered on freeways as well as congested traffic, which is observed mainly in cities and suburban areas, exchange of information between drivers of vehicles can play a crucial role in preventing mishaps. This information has to be communicated quickly, with ease, and it also has to be clear and concise. The information may include safety messages or warning messages. For example, police cars may need to communicate messages such as “STAY IN YOUR CAR”, or “PULL OVER”, and an ambulance may need to communicate messages such as “EMERGENCY”.

Typically, vehicles include signals that indicate what the vehicle driver is doing or is going to do, such as braking signals, turning signals, and car-in-reverse signals. There are other signals such as hazard signals that indicate that there is an unsafe condition that is being encountered. Some of these signals may occur without a separate action of the driver. For example, brake signals may be activated whenever the driver steps on the brake pedal and car-in-reverse signals may be activated whenever the driver places the car in reverse gear. Other signals may require a separate action of the driver, such as moving the turn signal lever or pressing a hazard signal lever or button.

Various systems for vehicle communication have been proposed. Generally, these involve the signaling of preselected messages from one vehicle to another in response to a manual operation of a switch to select the message to be communicated. Some of the proposed methods may include messages that are only pre-programmable to be displayed at the rear of the vehicle in a static manner. Some of the conventional solutions are described below, the contents of which, in their entireties, are herein incorporated by reference. U.S. patent application publication 2014/0005860 discloses automotive communication devices and signs for automotive use. The device is primarily adapted for exterior use although it may be placed against a flat surface of a window internally using a suction cup, which may not be stable during bumpy driving.

U.S. patent application publication 2004/0097195 discloses a two-way, reciprocal, visual messaging system comprising a portable electronic command terminal and at least one portable, external, electronic display in communication with the command terminal. It is designed for casual communication between vehicles that are positioned side by side and the displays are positioned on a flat surface such as a window. Chinese patent application number 2010/17599 describes a taxi electronic signboard, which includes an installation casing body and an electronic display screen. The electronic display screen is matched and arranged inside the installation casing body. The signboard is fixed on the top part of the taxi body, and a car-carried battery supplies the power source. The taxi signboard is particularly suitable for indicating the formal and legal status of the taxi, and is also an advertising information carrier.

U.S. Pat. No. 7,659,808 provides a communication system with a vehicular displaying unit. The displaying unit allows one or more messages to be displayed on at least one of the front or rear windshield to other drivers. A remote control unit is provided for selecting from a list of preconfigured messages by the user in terms of content and appearance as well as for controlling the display of the messages. The messages are thus generally static in nature. U.S. patent application publication 2011/0258895 provides an automobile message display device. The device allows a user to compose a message on a first device, such as a cell phone, computer, or other personal electronic device and download the message to the automobile message display device. This download may be accomplished with a cable connection, or may be done wirelessly. The display device is typically configured to be placed on the exterior of the vehicle as a substitute for a bumper sticker, which could be subject to damage, destruction, vandalism, and weathering effects.

U.S. patent application publication 2005/0083183 provides a device that includes a remote control and an electronic LED display panel box. The preprogrammed words, phrases, signs, or numbers are stored in a read/write memory of the LED display panel. A driver can press a button to express a courteous message displayed through a visual display panel. The display panel is usually seated on a rear dashboard behind the rear seat with two pieces of double side foam tape or Velcro™ connection. The display panel can also be directly attached on the rear or side window of an automobile with suction cups, which may not be suitable for bumpy conditions.

U.S. Pat. No. 8,875,426 provides a signage system that includes one or more visual display devices, each of which is mounted for display behind a windshield of one or more parked and ignition-off vehicles. The sign has a visual display surface that is capable of forming an illuminated graphic display on the visual display surface. The visual display surface would be placed adjacent to the windshield of a vehicle so that the visual display surface would be visible to observers in front of the vehicle. The signage system includes wireless communication hardware that allows the visual display to be programmed by a remote programming device. However, the system is primarily suited for display on stationary vehicles for marketing and not for moving vehicles.

The conventional devices and systems generally do not provide a complete solution for dynamic stable communication to be broadcast from a vehicle. Accordingly, there remains a need for a removable and stable electronic display device mounted inside a vehicle that enables dynamic communication with persons within a viewing range from the vehicle.

### SUMMARY

In view of the foregoing, an embodiment herein provides an electronic vehicle accessory device adapted to fit on a dashboard of a vehicle, comprising: a control, communication, and power circuit board that processes an input from a communication device that comprises a message; a display unit that comprises a light-emitting diode (LED) circuit board comprising a plurality of light-emitting diodes adapted to dynamically display an electronic sign that comprises the message received from the communication device; a translucent lens that is positioned in front of the LED circuit board to diffuse the electronic sign from the LED circuit board; a housing unit that encloses the LED circuit board, the control, communication, and power circuit board, and the translucent lens; a plurality of legs comprising any of elastomeric, plastic, and adhesive material to permit the device to be stably but removably fixed on the dashboard of the vehicle; and an inclined front surface adapted to fit adjacent to a windshield of the vehicle.

The electronic vehicle accessory may further comprise a bezel retained by the housing unit that maintains the translucent lens in position. The electronic vehicle accessory may further comprise a communication circuit in the control, communication, and power circuit board that is connected to the communication device using any of a wired connection and a wireless connection. The electronic vehicle accessory may further comprise a power mechanism to power the control, communication, and power circuit board. The communication device may comprise any of a mobile phone, a smartphone, a tablet, a laptop, and a portable electronic device. The LED circuit board may broadcast any of alphanumeric messages and symbol messages.

The message may be dynamically displayed as the electronic sign in the display unit by any of: scrolling the message left to right; scrolling the message right to left; scrolling the message up to down; scrolling the message down to up; changing the message from a small font to a large font; changing the message from a large font to small font; the message flashing; the message changing color; a display background flashing; the display background changing color; the message font alternating between normal and bold; the message font alternating between normal and italicized; the message displayed in multiple languages; the message displayed in reverse; and any display of text, color, symbols, and fonts.

The housing unit may comprise at least one bumper positioned on a front edge of the housing unit. The housing unit may comprise a bottom surface that is adapted to be adjacent to the dashboard, and wherein the bottom surface comprises any of an inclined surface and a curved surface.

Another embodiment provides an electronic vehicle accessory device mounted on a dashboard of a vehicle for dynamically displaying a message, the electronic vehicle accessory device comprising: a LED board that comprises a plurality of light emitting diodes to dynamically displaying the message; a control, communication, and power circuit board that is powered using a power mechanism, wherein the control, communication, and power circuit board receives an input from a user via a communication device and processes the input to obtain the message that comprises text; a translucent lens that is positioned in front of the LED circuit board to diffuse the electronic sign from the LED circuit board; a bezel that retains the translucent lens in position; and a housing unit that retains the bezel and encloses the LED circuit board, the control, communication, and power circuit board, and the translucent lens, wherein the text is dynamically displayed as the electronic sign in the display unit by any of: scrolling the text left to right; scrolling the text right to left; scrolling the text up to down; scrolling the text down to up; changing the text from a small font to a large font; changing the text from a large font to small font; the text flashing; the text changing color; a display background flashing; the display background changing color; the text font alternating between normal and bold; the text font alternating between normal and italicized; the text displayed in multiple languages; the text displayed in reverse, and any display of text, color, symbols, and fonts.

The LED circuit board may broadcast any of alphanumeric messages and symbol messages. The electronic vehicle accessory may further comprise a communication circuit in the control, communication, and power circuit board is connected to the communication device using any of wired and wireless connection. The power mechanism may comprise any of a connection to vehicle power, a battery, and solar cells. The communication device may comprise any of a mobile phone, a smartphone, a tablet, a laptop, and a portable electronic device. The housing unit may comprise a bottom surface that is adapted to be adjacent to the dashboard, wherein the bottom surface may comprise any of an inclined surface and a curved surface. The input received from the user may comprise any of a text, and a voice. The housing unit may comprise an inclined front surface adapted to fit adjacent to a windshield of the vehicle. The housing unit may comprise at least one bumper positioned on a front edge of the housing unit. The at least one bumper may comprise elastomeric material. The housing unit may be configured in a trapezoid shape. The electronic vehicle accessory device may further comprise a plurality of legs comprising any of elastomeric, plastic, and adhesive material to permit the device to be stably but removably fixed on the dashboard of the vehicle

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user providing information to a communication device to be displayed on an electronic vehicle accessory device according to an embodiment herein;

FIG. 2 illustrates a cross-sectional view of the electronic vehicle accessory device of FIG. 1 according to an embodiment herein;

FIG. 3A illustrates a top view of the electronic vehicle accessory device of FIG. 2 according to an embodiment herein;

FIG. 3B illustrates a front view of the electronic vehicle accessory device of FIG. 2 according to an embodiment herein;

FIG. 3C illustrates a right side view of the electronic vehicle accessory device of FIG. 2 according to an embodiment herein;

FIG. 3D illustrates a perspective view of the electronic vehicle accessory device of FIG. 2 according to an embodiment herein;

FIG. 3E illustrates a right side view of the electronic vehicle accessory device of FIG. 2 according to another embodiment herein;

FIG. 3F illustrates a right side view of the electronic vehicle accessory device of FIG. 2 according to another embodiment herein;

FIG. 4 illustrates a perspective view of the electronic vehicle accessory device of FIG. 2 mounted on a dashboard of a vehicle according to an embodiment herein; and

FIG. 5 illustrates an exploded view of a communication device of FIG. 1 according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned there remains a need for a removable and stable electronic display device mounted inside a vehicle that enables dynamic communication with persons within a viewing range from the vehicle. The embodiments herein achieve this by a providing an electronic vehicle accessory device that includes a light-emitting diode (LED) circuit board, a control, communication, and power circuit board that receives an input from a user via a communication device that is dynamically displayed as an electronic sign in the display unit, and a plurality of legs that are adapted to fix the electronic vehicle accessory device to a dashboard of a vehicle and to fit behind a curved/angled windshield of the vehicle.

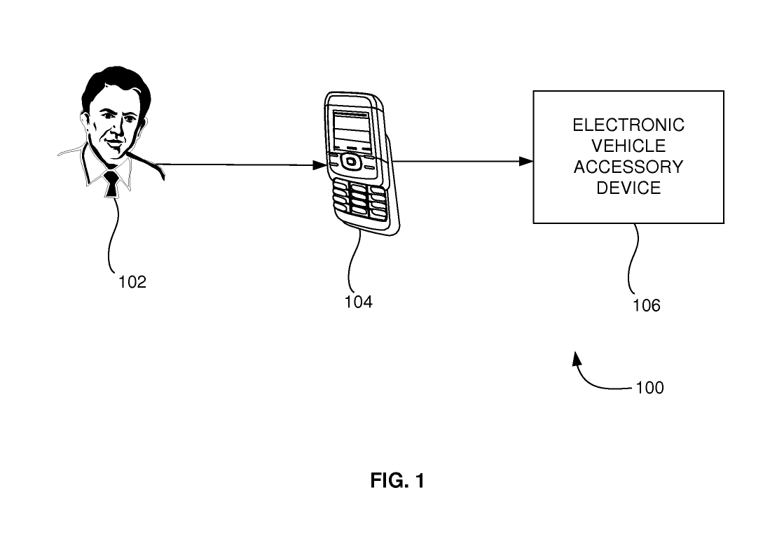

According to the embodiments herein, the electronic signs are dynamic and changeable by the user. In the context of the embodiments herein, dynamic refers to the ability of the signs/text/messages to be changed by the user at will without requiring a pre-programmed set of messages that must be displayed. By comparison, static messaging as provided by the conventional solutions refers to signs/text/messages that cannot be changed by the user or only are selected based on a pre-programmed menu of signs/text/messages. Referring now to the drawings, and more particularly to FIGS. 1 through 5, where similar reference characters denote corresponding features consistently throughout the figures, there are shown preferred embodiments.

FIG. 1 illustrates a system 100 including a user 102 providing information to a communication device 104 to be displayed on an electronic vehicle accessory device 106 according to an embodiment herein. The electronic vehicle accessory device 106 may be mounted onto a dashboard of a vehicle to fit adjacent to a curved/angled front windshield of the vehicle. The communication device 104 may be connected to the electronic vehicle accessory device 106 via a wired connection or a wireless connection. The electronic vehicle accessory device 106 receives the information, processes it, and dynamically displays the information as an electronic sign in a display unit to communicate with persons within a viewing range of the vehicle. The communication device 104 may be a mobile phone, a tablet, a laptop, or some other portable electronic device, etc.

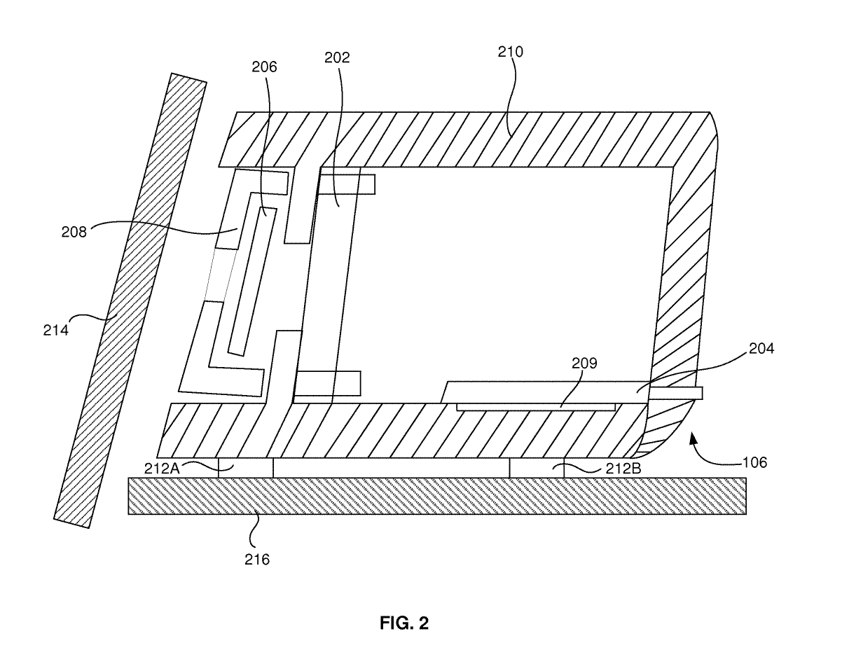

FIG. 2 illustrates a sectional view of the electronic vehicle accessory device 106 of FIG. 1 according to an embodiment herein. The sectional view includes a light-emitting diode (LED) circuit board 202, a control, communication, and power circuit (CCPC) board 204, a translucent lens 206, a bezel 208, a housing unit 210, and a plurality of legs 212A-B. Further illustrated is a windshield 214 of the vehicle and a dashboard 216 of the vehicle. The LED circuit board 202 includes one or more light-emitting diodes to act as a display unit. The LED circuit board 202 broadcasts messages that may include alphanumeric text and/or symbols. The control, communication, and power circuit board 204 may be powered using a power mechanism 209 such as a connection to the vehicle power, battery power, solar cells, etc. in example embodiments.

The control, communication, and power circuit board 204 receives an input from the user 102 via the communication device 104 and processes the input. The processed input is dynamically displayed as the electronic sign in the LED circuit board (i.e., display unit) of the electronic vehicle accessory device 106. The input includes text and/or voice input. The voice input may be converted into text using speech recognition software in the communication device 104 in one embodiment.

In one example embodiment, the control, communication, and power circuit board 204 is powered using the battery (not shown) of the vehicle. The device 106 may include a Liquid Crystal Display (LCD). The translucent material 206 is positioned in front of the LED circuit board to diffuse the electronic sign from the LED circuit board 202. The bezel 208 retains the translucent lens 206 in position. The housing unit 210 retains the bezel 208 and encloses the LED circuit board 202, the control, communication, and power circuit board 204, and the translucent lens 206. The legs 212A-B are adapted to stably but removably fix the electronic vehicle accessory device 106 on a dashboard 216 of the vehicle. In one embodiment, the legs 212A-B are made of an elastomeric material, and in other embodiments, the legs 212A-B comprise any of plastic features or adhesive features to allow for the stable yet removable functionality.

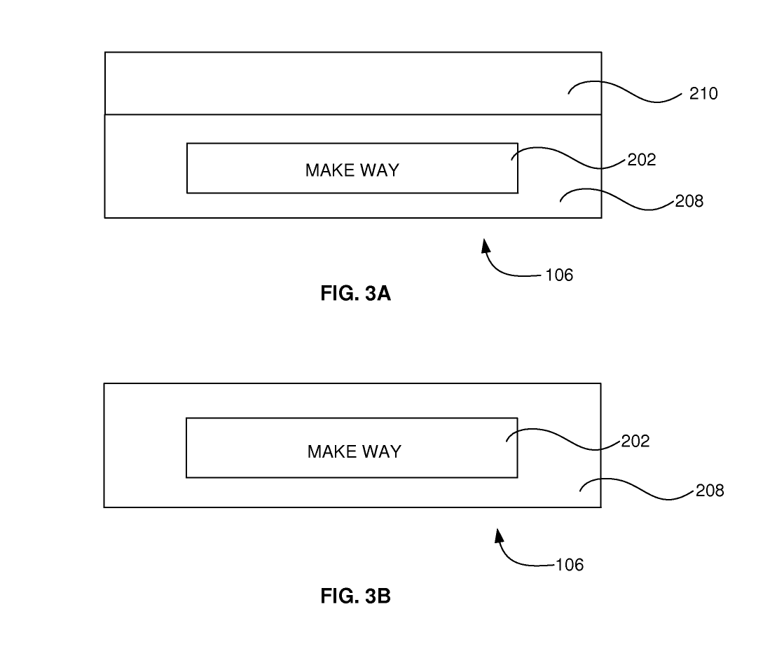

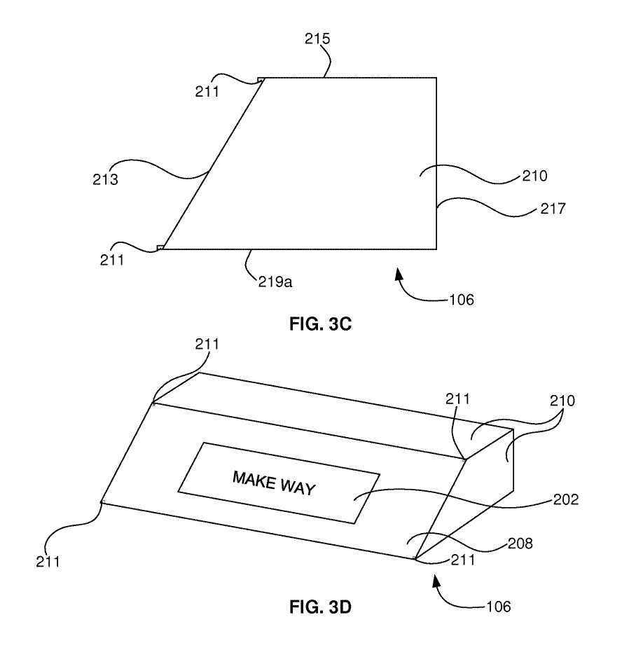

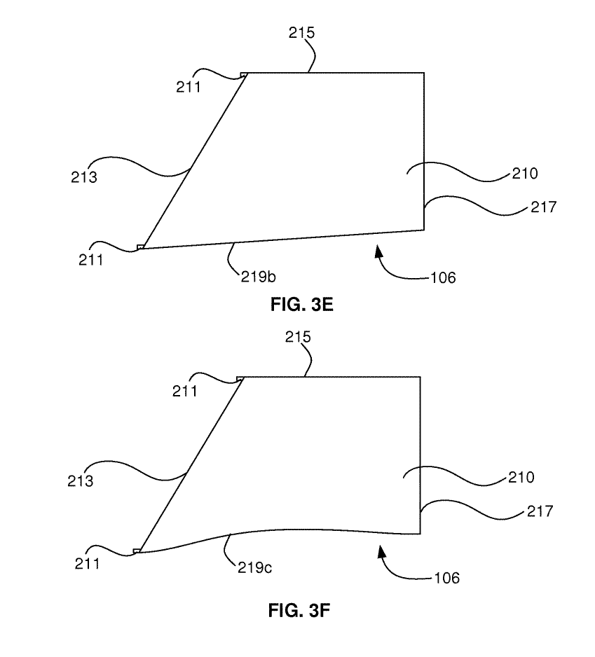

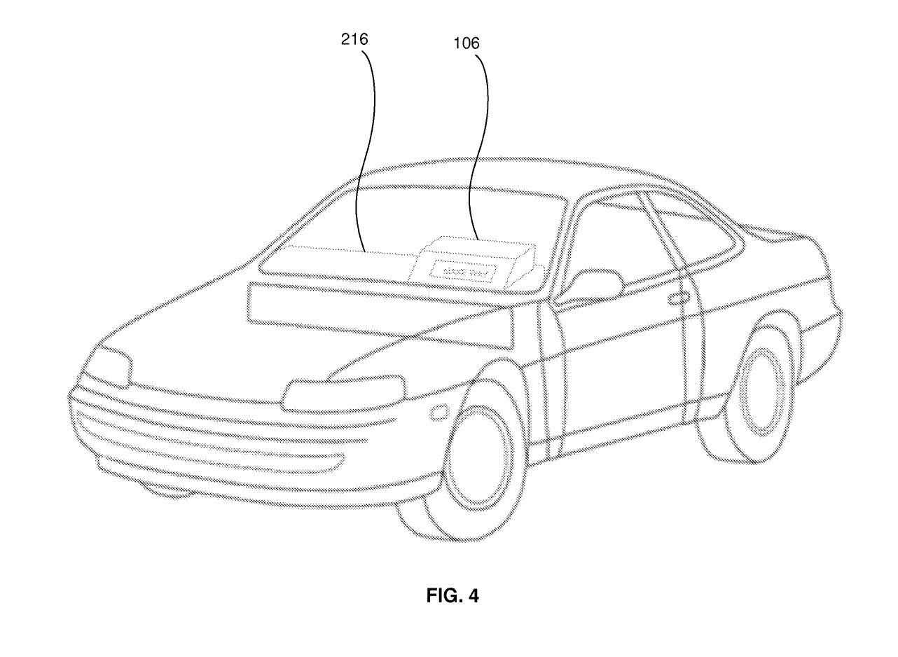

FIG. 3A illustrates a top view of the electronic vehicle accessory device 106 of FIG. 2 according to an embodiment herein. The top view shows the LED circuit board 202, the bezel 208, and the housing unit 210 of the electronic vehicle accessory device 106. FIG. 3B illustrates a front view of the electronic vehicle accessory device 106 of FIG. 2 according to an embodiment herein. The front view shows the LED circuit board 202, and the bezel 208 of the electronic vehicle accessory device 106. FIG. 3C illustrates a right side view of the electronic vehicle accessory device 106 of FIG. 2 according to an embodiment herein. The right side view shows the housing unit 210 of the electronic vehicle accessory device 106.

FIG. 3D illustrates a perspective view of the electronic vehicle accessory device 106 of FIG. 2 according to an embodiment herein. The perspective view shows the LED circuit board 202, the bezel 208, and the housing unit 210 of the electronic vehicle accessory device 106. The electronic vehicle accessory device 106 may be shaped like a prism with an inclined surface 213 (shown in FIG. 3C) adapted to fit adjacent to the slightly angled or curved windshield 214. As further shown in FIG. 3C, the electronic vehicle accessory device 106 may be trapezoid-like in shape with a top surface 215, a back surface 217 that is somewhat perpendicular to the top surface 215, an inclined front surface 213, and a bottom surface 219a that is somewhat parallel to the top surface 215. In another embodiment, the bottom surface 219b may have a slight incline (shown in FIG. 3E) and/or may have a slightly curved bottom surface 219c (shown in FIG. 3F) to better conform to the fit of vehicle dashboards 216 and to provide stable and removable functionality of the device 106. The electronic display board may display a text (e.g., MAKE WAY) as shown in FIGS. 3A, 3B, and 3D. This distinct configuration permits the device 106 to comfortably fit on a dashboard 216 of a vehicle without falling off, and the configuration also allows for proper positioning of the device 106 adjacent to the front windshield 214 to allow for full visibility of the displayed message(s). Also, by being positioned inside the vehicle, the device 106 is less prone to damage, destruction, vandalism, and weathering effects compared with an external mounting device. Moreover, the device 106 may include elastomeric front bumpers 211 (shown in FIGS. 3C-3F) on some of the front edges of the housing unit 210 to assist in positioning of the device 106. FIGS. 3C, 3E, and 3F do not show the legs 212A-B such that the device 106 may be configured with or without the legs 212A-B or the legs 212A-B in combination with any of the straight, inclined, or curved bottom surface (219a, 219b, 219c) of the device 106.

The text/sign/message may be dynamically displayed as an electronic sign in the LED circuit board 202 in the following ways but are not limited to: (a) scrolling the text/sign/message left to right, (b) scrolling the text/sign/message right to left, (c) scrolling the text/sign/message up to down, (d) scrolling the text/sign/message down to up, (e) changing the text/sign/message from a small font to a large font, (f) changing the text/sign/message from a large font to a small font, (g) the text/sign/message flashing, (h) the text/sign/message changing color, (i) a display background flashing, (j) the display background changing color, (k) the text/sign/message font alternating between normal and bold, (l) the text/sign/message font alternating between normal and italicized, (m) the text/sign/message displayed in multiple languages, (n) the displayed text/sign/message reversed, and (o) any display of text, color, symbols, and fonts.

FIG. 4, with reference to FIGS. 1 through 3F, illustrates a perspective view of the electronic vehicle accessory device 106 of FIG. 2 mounted on a dashboard 216 of a vehicle 400 according to an embodiment herein. FIG. 4 shows the electronic vehicle accessory device 106 stably but removably fixed to the dashboard 216 adjacent to the slightly curved or angled windshield 214 of the vehicle 400. Other drivers/persons can view the electronic message(s) clearly when the electronic vehicle accessory device 106 is installed on the dashboard 216. The legs 212A-B of the electronic vehicle accessory device 106 are adapted to stay stable on the dashboard 216 of the vehicle 400 even when the user 102 is driving through bumpy roads or is driving at a high speed with twists and turns.

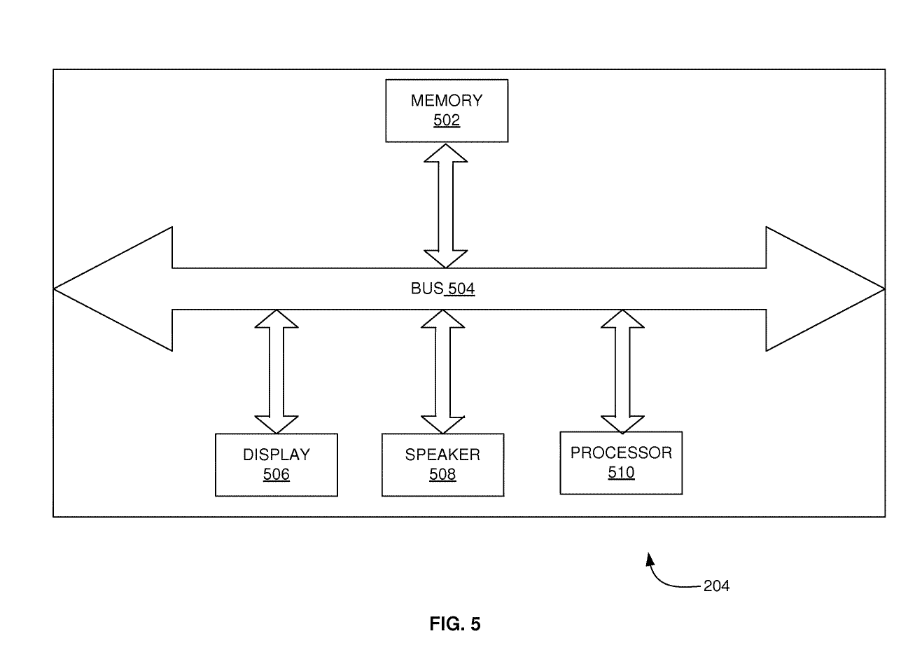

FIG. 5, with reference to FIGS. 1 through 4, illustrates an exploded view of the a control, communication, and power circuit (CCPC) board 204 of FIG. 2 having a memory 502 having a set of instructions, a bus 504, an optional operatively connected display 506, a speaker 508, and a processor 510 capable of processing the set of instructions to perform one or more of the methodologies, according to an embodiment herein. The memory may store a speech recognition software to convert a voice input received from a microphone (e.g., not shown) into text. The processor 510 may also enable dynamic messages to be viewed via one or more displays 506 or audio for output or heard via speaker and/or earphones 508. A user 102 of the communication device 104 of FIG. 1 may view this stored information on display 506 of the communication device 104 and select an item of for viewing, listening, or other uses via input, which may take the form of keypad, scroll, or other input device(s) or combinations thereof.

The electronic vehicle accessory device 106 is installed in the vehicle 400 to display electronic signs to communicate between users. The electronic vehicle accessory device 106 includes the one or more legs 212A-B that are adapted to stably but removably fix the electronic vehicle accessory device 106 on the dashboard 216 of the vehicle even when the user 102 is driving fast through bumpy or curved roads. The legs 212A-B can be elastomeric, plastic, or contain adhesive material, or a combination thereof, to allow for flexible positioning and mounting of the electronic vehicle accessory device 106. Moreover, the configuration of the bottom surface (e.g, 219a, 219b, 219c) of the device 106 can permit further stability and ease of removal of the device 106 from the vehicle 400.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An electronic vehicle accessory device adapted to fit on a dashboard of a vehicle, comprising:
a control, communication, and power circuit board that processes an input from a communication device that comprises a message;
a display unit that comprises a light-emitting diode (LED) circuit board comprising a plurality of light-emitting diodes adapted to dynamically display an electronic sign that comprises said message received from said communication device;
a translucent lens that is positioned in front of said LED circuit board to diffuse said electronic sign from said LED circuit board;
a housing unit that encloses said LED circuit board, said control, communication, and power circuit board, and said translucent lens;
a plurality of legs comprising any of elastomeric, plastic, and adhesive material to permit the device to be stably but removably fixed on said dashboard of said vehicle; and
an inclined front surface adapted to fit adjacent to a windshield of said vehicle.

2. The electronic vehicle accessory device of claim 1, further comprising a bezel retained by said housing unit that maintains said translucent lens in position.

3. The electronic vehicle accessory device of claim 1, further comprising a communication circuit in said control, communication, and power circuit board that is connected to said communication device using any of a wired connection and a wireless connection.

4. The electronic vehicle accessory device of claim 1, further comprising a power mechanism to power said control, communication, and power circuit board.

5. The electronic vehicle accessory device of claim 1, wherein said communication device comprises any of a mobile phone, a smartphone, a tablet, a laptop, and a portable electronic device.

6. The electronic vehicle accessory device of claim 1, wherein said LED circuit board broadcasts any of alphanumeric messages and symbol messages.

7. The electronic vehicle accessory device of claim 1, wherein said message is dynamically displayed as said electronic sign in said display unit by any of:
scrolling said message left to right;
scrolling said message right to left;
scrolling said message up to down;
scrolling said message down to up;
changing said message from a small font to a large font;
changing said message from a large font to small font;
said message flashing;
said message changing color;
a display background flashing;
said display background changing color;
said message font alternating between normal and bold;
said message font alternating between normal and italicized;
said message displayed in multiple languages;
said message displayed in reverse; and
any display of text, color, symbols, and fonts.

8. The electronic vehicle accessory device of claim 1, wherein said housing unit comprises at least one bumper positioned on a front edge of said housing unit.

9. The electronic vehicle accessory device of claim 1, wherein said housing unit comprises a bottom surface that is adapted to be adjacent to said dashboard, and wherein said bottom surface comprises any of an inclined surface and a curved surface.

10. An electronic vehicle accessory device mounted on a dashboard of a vehicle for dynamically displaying a message, said electronic vehicle accessory device comprising:
a light-emitting diode (LED) board that comprises a plurality of light emitting diodes to dynamically displaying said message;
a control, communication, and power circuit board that is powered using a power mechanism, wherein said control, communication, and power circuit board receives an input from a user via a communication device and processes said input to obtain said message that comprises text;
a translucent lens that is positioned in front of said LED circuit board to diffuse said electronic sign from said LED circuit board;
a bezel that retains said translucent lens in position; and
a housing unit that retains said bezel and encloses said LED circuit board, said control, communication, and power circuit board, and said translucent lens,
wherein said text is dynamically displayed as said electronic sign in said display unit by any of:
scrolling said text left to right;
scrolling said text right to left;
scrolling said text up to down;
scrolling said text down to up;
changing said text from a small font to a large font;
changing said text from a large font to small font;
said text flashing;
said text changing color;
a display background flashing;
said display background changing color;
said text font alternating between normal and bold;
said text font alternating between normal and italicized;
said text displayed in multiple languages;
said text displayed in reverse; and
any display of text, color, symbols, and fonts.

11. The electronic vehicle accessory device of claim 10, wherein said LED circuit board broadcasts any of alphanumeric messages and symbol messages.

12. The electronic vehicle accessory device of claim 10, further comprising a communication circuit in said control, communication, and power circuit board is connected to said communication device using any of wired and wireless connection.

13. The electronic vehicle accessory device of claim 10, wherein said power mechanism comprises any of a connection to vehicle power, a battery, and solar cells.

14. The electronic vehicle accessory device of claim 10, wherein said communication device comprises any of a mobile phone, a smartphone, a tablet, a laptop, and a portable electronic device.

15. The electronic vehicle accessory device of claim 10, wherein said housing unit comprises a bottom surface that is adapted to be adjacent to said dashboard, and wherein said bottom surface comprises any of an inclined surface and a curved surface.

16. The electronic vehicle accessory device of claim 10, wherein said input received from said user comprises any of a text, and a voice.

17. The electronic vehicle accessory device of claim 10, wherein said housing unit comprises an inclined front surface adapted to fit adjacent to a windshield of said vehicle.

18. The electronic vehicle accessory device of claim 10, wherein said housing unit comprises at least one bumper positioned on a front edge of said housing unit.

19. The electronic vehicle accessory device of claim 18, wherein said at least one bumper comprises elastomeric material.

20. The electronic vehicle accessory device of claim 10, further comprising a plurality of legs comprising any of elastomeric, plastic, and adhesive material to permit the device to be stably but removably fixed on said dashboard of said vehicle.
